(19) United States
(12) Patent Application Publication
(10) Pub. No.: US 2005/0152471 A1
(43) Pub. Date: Jul. 14, 2005

(54) Transmitting device

(75) Inventors: Koichiro Tanaka, Takarazuka-shi (JP); Mitsuru Tanabe, Katano-shi (JP)

Correspondence Address: MERCHANT & GOULD PC, P.O. BOX 2903, MINNEAPOLIS, MN, 55402-0903, US

(73) Assignee: Matsushita Electric Industrial Co., Ltd., Kadoma-shi (JP)

(21) Appl. No.: 11/029,875

(22) Filed: Jan. 5, 2005

(30) Foreign Application Priority Data
Jan. 8, 2004 (JP) 2004-003309

(51) Int. Cl. H04L 27/04

(52) U.S. Cl. 375/295

(57) ABSTRACT

A transmitting device is provided, which is capable of outputting a modulated wave which suffers little deterioration in modulation accuracy, spectrum and the like, even in the case of using a high-frequency power amplifier in which the fluctuation in phase difference between input and output is large when a bias voltage is changed. A complex number table (6) outputs a complex number that compensates for a phase shift of a high-frequency power amplifier (5) in accordance with the value of the amplitude component of a modulated signal output from an envelope detecting section (2). A complex number multiplier (7) outputs a phase-compensated modulated signal to a quadrature modulator (4). An amplitude conversion table (8) converts the amplitude component output from the envelope detecting section into a value in a predetermined range that excludes zero. Based on this value, a voltage source (3) generates a bias voltage and provides the bias voltage to a power supply terminal of the high-frequency power amplifier. The high-frequency power amplifier is driven by the bias voltage, amplifies a high-frequency band phase-compensated modulated signal output from the quadrature modulator, and outputs a modulated wave whose amplitude and phase vary.

### BACKGROUND OF THE INVENTION

1. Field of the Invention

The present invention relates to transmitting devices that output modulated high-frequency signals.

2. Related Background Art

Generally, in modulated signals involving amplitude modulation, particularly in M-ary modulation such as QAM (quadrature amplitude modulation), high-frequency power amplifiers for transmitting radio frequency power to antennas need to perform linear operation. For this reason, class-A, or class-AB has been used as the operation class of high-frequency power amplifiers.

However, with the advances in broadband communications, communication modes using multi carriers, such as OFDM (orthogonal frequency division multiplex), have begun to be used, and the conventional class-A or class-AB high-frequency power amplifiers cannot be expected to achieve high efficiency. More specifically, in OFDM, high power is generated instantaneously by superposition of subcarriers, so that the ratio of the maximum peak power to the average power, i.e., PAPR (peak-to-average power ratio) is large. Therefore, the high-frequency power amplifiers need to constantly maintain a high DC power so as to linearly amplify high-frequency signals having such a high power. In class-A operation, the power supply efficiency is only 50% at the maximum. Particularly, since the PAPR is large in the case of OFDM, the power supply efficiency is about 10%, which is extremely low.

This results in, for example, a reduction in the maximum time of continuous operation for portable wireless devices using a battery as a power source, causing a problem for their practical use.

In order to solve the above-described problems, the conventional EER (envelope elimination and restoration) technique known as Kahn-technique has been proposed (see e.g., U.S. Pat. No. 6,256,482: Sheet 3 of the drawings, FIG. 6).

In this configuration, an input high-frequency modulated signal is branched into two signals. One of the signals is envelope-detected, and becomes an amplitude component. This amplitude component becomes a bias voltage whose amplitude is varied with an amplitude modulator constituted by a switching regulator and the like, and is supplied to a power supply terminal of a high-frequency power amplifier. The other branched signal is amplitude-controlled by an amplitude control amplifier (limiter), and becomes a phase-modulated wave in which only the phase has been modulated. This phase-modulated wave is supplied to a high-frequency input terminal of the high-frequency power amplifier.

In the EER technique, a high-efficiency switching amplifier can be used as the high-frequency power amplifier, and the minimum supply voltage required for power amplification is supplied to the power supply terminal of the high-frequency power amplifier. Consequently, the power supply efficiency can be improved.

Another EER technique suitable for digital signal processing has been proposed, in which a phase-modulated wave is obtained by quadrature modulation of a complex envelope signal (see e.g., JP H3-34709A (page 5, FIG. 1)). In this configuration, a modulated signal with a residual amplitude modulation is supplied as a phase-modulated wave to the high-frequency power amplifier. FIG. 8 is a block diagram schematically showing a conventional transmitting device using this EER technique. As shown in FIG. 8, this transmitting device includes: a modulated signal generating section 1 that outputs a modulated signal; an envelope detecting section 2 that receives one of two branched modulated signals; a voltage source 3 that receives an output signal of the envelope detecting section 2; a quadrature modulator 4 that receives the other of the two branched modulated signals; and a high-frequency power amplifier (PA) 5 whose power supply terminal receives an output voltage of the voltage source 3 and whose high-frequency input terminal receives an output signal of the quadrature modulator 4.

Here, the envelope detecting section 2 and the voltage source 3 correspond to a bias driving section, and the quadrature modulator 4 corresponds to a high-frequency driving section.

In the following, the operation of a conventional transmitting device having such a configuration is described with reference to FIG. 8.

The modulated signal generating section 1 carries out modulation such as QAM or OFDM based on data generated internally or data supplied externally, and outputs a modulated signal represented by a complex envelope. The envelope detecting section 2 outputs an amplitude component by determining the absolute value of the complex envelope representing the modulated signal. The voltage source 3 generates a bias voltage in accordance with the amplitude component. The quadrature modulator 4 outputs a high-frequency signal by quadrature-modulating the modulated signal represented by the complex envelope. The high-frequency power amplifier 5 outputs a modulated wave whose amplitude and phase vary, by amplifying the high-frequency signal to an amplitude in accordance with the bias voltage.

In addition, there is another known configuration which obtains a highly accurate modulated wave by compensating for non-linearity in the output voltage with respect to the bias voltage of the high-frequency power amplifier 5 (see e.g., JP H-6-54878B (page 3, the right column)).

However, the conventional transmitting devices may not be able to obtain a sufficiently accurate modulated wave even when the non-linearity of the output voltage with respect to the bias voltage of the high-frequency power amplifier 5 is compensated. When an actual measurement was carried out using a commercially available semiconductor amplifier for 5 GHz band as a high-frequency power amplifier, taking as an example an OFDM modulation based on the IEEE 802.11a standard, EVM (error vector magnitude), which represents the modulation accuracy, was as large as about 10%, and thus was inadequate for achieving high-speed data transmission. Furthermore, the next adjacent channel leakage power ratio, which represents one aspect of the spectral accuracy, was as large as about −30 dB, and was unable to satisfy the above-described standard.

As a result of examining the input-output characteristics of the high-frequency power amplifier, it was found that when the bias voltage is changed, the fluctuation in phase difference between input and output was large and the phase of the output modulated wave was deviated from the desired value, so that there was a significant deterioration in modulation accuracy, spectrum and the like.

### SUMMARY OF THE INVENTION

Therefore, it is an object of the present invention to provide a transmitting device capable of outputting a modulated wave which suffers little deterioration in modulation accuracy, spectrum and the like, even when using a high-frequency power amplifier in which the fluctuation in phase difference between input and output is large when a bias voltage is changed.

In order to achieve the above-described object, a first transmitting device according to the present invention includes: a modulated signal generating section that generates a modulated signal; a high-frequency driving section that generates a high-frequency driving signal in response to the modulated signal; a high-frequency power amplifier that amplifies the high-frequency driving signal; and a bias driving section that detects an amplitude of the modulated signal and changes a bias voltage of the high-frequency power amplifier in accordance with a detected amplitude. The high-frequency power amplifier outputs a modulated wave whose amplitude and phase vary. The high-frequency driving section includes an amplitude versus phase function section and provides, to the high-frequency driving signal, a phase shift that is opposite to a phase shift between input and output of the high-frequency power amplifier that occurs when the bias voltage of the high-frequency power amplifier changes with the amplitude of the modulated signal.

With this configuration, it is possible to cancel the fluctuation in phase difference between the input and output of the high-frequency power amplifier that occurs when the bias voltage of the high-frequency power amplifier changes, thus reducing the phase error included in a modulated wave.

A second transmitting device according to the present invention has a configuration in which the high-frequency driving section includes a frequency converting section in the first transmitting device. With this configuration, it is possible to decrease the frequency of a modulated signal generated in the modulated signal generating section and the frequencies used in each section to which this modulated signal is input.

A third transmitting device according to the present invention includes: a modulated signal generating section that generates a modulated signal; a high-frequency driving section that generates a high-frequency driving signal in response to the modulated signal; a high-frequency power amplifier that amplifies the high-frequency driving signal; and a bias driving section that detects an amplitude of the modulated signal and changes a bias voltage of the high-frequency power amplifier in accordance with a detected amplitude. The high-frequency power amplifier outputs a modulated wave whose amplitude and phase vary. The bias driving section includes an amplitude versus amplitude function section and provides v with a value in a predetermined range that excludes zero with respect to a full range of values that a can assume, where a represents an amplitude of the modulated signal and v represents a bias voltage of the high-frequency power amplifier.

With this configuration, it is possible to prevent the bias voltage of the high-frequency power amplifier from being reduced to a low voltage close to zero, and especially, to reduce the phase error included in a modulated wave in the case of using a high-frequency power amplifier in which the fluctuation in phase difference between input and output is large when a bias voltage is changed, when the bias voltage of the high-frequency power amplifier is low. Furthermore, since the bias voltage does not have to be driven close to zero, it is possible to simplify the circuit of the voltage source that generates the bias voltage. For example, it is not necessary to provide a negative power supply as the operating voltage of the voltage source.

A fourth transmitting device according to the present invention has a configuration in which the high-frequency driving section of the third transmitting device includes a frequency converting section. With this configuration, it is possible to decrease the frequency of a modulated signal generated in the modulated signal generating section and the frequencies used in each section to which this modulated signal is input.

A fifth transmitting device according to the present invention has a configuration in which the amplitude versus amplitude function section outputs a value proportional to the sum of its input signal and a predetermined constant in the third transmitting device. With this configuration, it is possible to design the amplitude versus amplitude function section with a simple circuit.

A sixth transmitting device according to the present invention has a configuration in which a rate of change of y with respect to x is set to be smaller than a predetermined value when x is smaller than a predetermined value, where x represents an absolute value of an input signal and y represents an absolute value of an output signal of the amplitude versus amplitude function section, in the third transmitting device. With this configuration, it is possible to render an output waveform of the amplitude/phase amplitude section smooth, thus reducing the necessary frequency band for the bias driving section including the amplitude versus amplitude function section.

A seventh transmitting device according to the present invention has a configuration in which the amplitude versus amplitude function section of the sixth transmitting device outputs a value proportional to the square root of the sum of the square of its input signal and a predetermined positive constant. With this configuration, it is possible to design the amplitude versus amplitude function section with a simple circuit by representing the amplitude versus amplitude function section by simple calculations.

The present invention achieves a remarkable effect of providing a transmitting device capable of outputting a modulated wave which suffers little deterioration in modulation accuracy, spectrum and the like, even in the case of using a high-frequency power amplifier in which the fluctuation in phase difference between input and output is large when a bias voltage is changed.

### BRIEF DESCRIPTION OF THE DRAWINGS

FIG. 1 is a circuit block diagram showing an example of the configuration of a transmitting device according to Embodiment 1 of the present invention.

FIG. 2 is a graph showing an example of the characteristics of a high-frequency power amplifier.

FIG. 3 is a graph showing an example of the characteristics of an amplitude versus phase function section.

FIG. 4 is a graph showing an example of the characteristics of an amplitude versus amplitude function section.

FIG. 5 is a graph showing an example of the characteristics of the amplitude versus amplitude function section.

FIG. 6 is a circuit block diagram showing an example of the configuration of a transmitting device according to Embodiment 2 of the present invention.

FIG. 7 is a graph showing an example of the characteristics of an amplitude versus phase function section.

FIG. 8 is a circuit block diagram showing an example of the configuration of a conventional transmitting device.

### DETAILED DESCRIPTION OF THE INVENTION

Hereinafter, preferred embodiments of the present invention are described in detail, with reference to the accompanying drawings.

### Embodiment 1

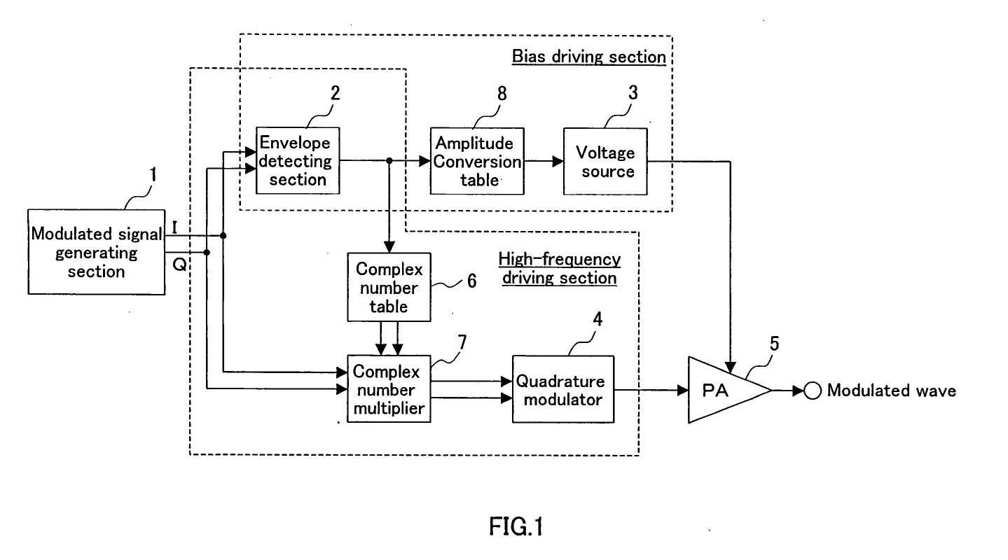

FIG. 1 is a circuit block diagram showing an example of the configuration of a transmitting device according to Embodiment 1 of the present invention. The transmitting device has a configuration that provides a modulated signal having a desired center frequency by generating a modulated signal in the baseband or a low frequency band and then performing frequency conversion. As shown in FIG. 1, the transmitting device includes: a modulated signal generating section 1 that outputs a modulated signal; an envelope detecting section 2 that receives one of two branched modulated signals; a complex number table 6 that receives one of two branched output signals from the envelope detecting section 2; a complex number multiplier 7 that receives the other of the two branched modulated signals and an output signal from the complex number table 6; a quadrature modulator 4 that receives an output signal from the complex number multiplier 7; an amplitude conversion table 8 that receives the other of the two branched output signals from the envelope detecting section 2; a voltage source 3 that receives an output signal from the amplitude conversion table 8; and a high-frequency power amplifier 5 whose power supply terminal receives an output voltage of the voltage source 3 and whose high-frequency input terminal receives an output signal of the quadrature modulator 4.

The envelope detecting section 2, the complex number table 6 and the complex number multiplier 7 correspond to an amplitude versus phase function section, and the quadrature modulator 4 corresponds to a frequency converting section. The amplitude versus phase function section and the frequency converting section correspond to a high-frequency driving section. Furthermore, the amplitude conversion table 8 corresponds to an amplitude versus amplitude function section, and the amplitude versus amplitude function section, the envelope detecting section 2 and the voltage source 3 correspond to a bias driving section.

In the following, the operation of a transmitting device according to this embodiment having the above-described configuration is described with reference to FIG. 1.

The modulated signal generating section 1 carries out a modulation such as QAM or OFDM based on data generated internally or data supplied externally, and outputs a modulated signal represented by a complex envelope. The envelope detecting section 2 outputs an amplitude component by determining the absolute value of the complex envelope representing the modulated signal. The complex number table 6 stores in advance a value that compensates for the fluctuation in phase difference between the input and output of the high-frequency power amplifier 5, and outputs a complex number that compensates for the variation in the phase difference in accordance with the value of the amplitude component output from the envelope detecting section 2. The complex number multiplier 7 complex-multiplies the modulated signal by the complex number that compensates for the phase fluctuation, thereby outputting a phase-compensated modulated signal. The quadrature modulator 4 frequency-converts the phase-compensated modulated signal based on a quadrature carrier (not shown) of a predetermined frequency, and outputs a high-frequency band modulated signal. The amplitude conversion table 8 converts the amplitude component output from the envelope detecting section 2 into a value in a predetermined range that excludes zero. The voltage source 3 generates a bias voltage based on the amplitude component in a predetermined range. The high-frequency power amplifier 5 is driven by the bias voltage supplied to the power supply terminal, amplifies the high-frequency band modulated signal, and outputs a high-frequency band modulated wave whose amplitude and phase vary.

Since the high-frequency driving section includes the quadrature modulator 4 constituting the frequency converting section, the modulated signal generating section 1 and the constituents that receive an output signal from the modulated signal generating section 1 do not need to handle a high-frequency band signal. Accordingly, it is possible to make use of digital signal processing, and to prevent the accuracy of the modulated wave from deteriorating due to a deviation in circuitry.

In the following, the operation of the amplitude versus phase function section composed of the envelope detecting section 2, the complex number table 6 and the complex number multiplier 7 is described in detail.

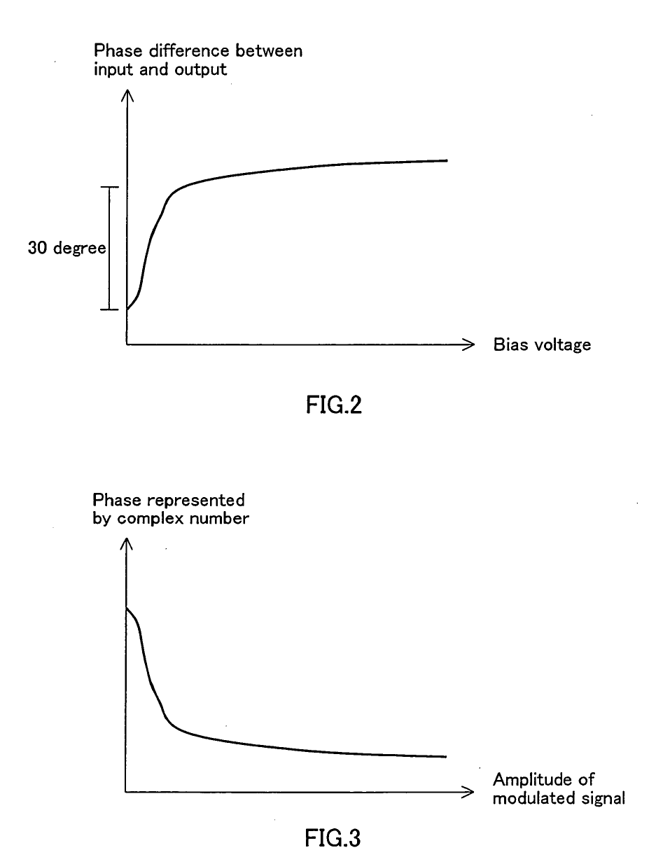

For the sake of simplicity, a case is described where the bias driving section is composed of the envelope detecting section 2 and the voltage source 3 as in the conventional configuration and does not include the amplitude conversion table 8. FIG. 2 shows an example in which the phase difference between the input and output of the high-frequency power amplifier varies with the bias voltage. In FIG. 2, the phase difference varies by several tens of degrees with the bias voltage. That is, since the bias voltage changes in accordance with the amplitude of the modulated signal, the high-frequency power amplifier adds an excess phase fluctuation of several tens of degrees to the modulated signal. The value of the bias voltage with respect to the value of the amplitude component output from the envelope detecting section 2 can be known from the characteristics of the voltage source 3, so that the above-described excess phase fluctuation for the value of the amplitude component can be known. A complex number that phase-rotates in the reverse direction with respect to the excess phase fluctuation is in advance stored in the complex number table 6. Then, the excess phase fluctuation is cancelled by inputting into the complex number multiplier 7, the complex number that is output for the value of the amplitude component, and multiplying the modulated signal by that complex number. FIG. 3 shows an example of the complex number stored in the complex number table 6.

In the following, the operation of the amplitude versus amplitude function section configured as the amplitude conversion table 8 is described in detail.

Again, reference is made to the above-described characteristics (FIG. 2) of the high-frequency power amplifier. As shown in FIG. 2, the high-frequency power amplifier often shows a significant fluctuation in phase difference between input and output with respect to the change in bias voltage, when the bias voltage is close to zero. The amplitude conversion table 8 converts the range of the value of the amplitude component output from the envelope detecting section 2 into a value in a range that excludes zero. In accordance with this value, the voltage source 3 outputs a bias voltage higher than a predetermined value. That is, the high-frequency power amplifier operates within a range where the fluctuation in phase difference between input and output is moderate, and the excess phase fluctuation added to the modulated signal become small. Accordingly, the phase fluctuation that should be cancelled with the amplitude versus phase function section becomes small.

This makes it possible to precisely cancel the excess phase fluctuation with the amplitude versus phase function section. Alternatively, when the phase fluctuation that should be cancelled is very small, it is possible to omit the amplitude versus phase function section. Furthermore, since the bias voltage that should be output from the voltage source 3 does not include zero, it is possible to simplify the circuit of the voltage source. For example, it is not necessary to provide a negative power supply for the operating voltage of the voltage source. In addition, a bias voltage that is not zero causes no problem, because a modulated wave whose amplitude varies to zero can be output by setting the amplitude of the high-frequency band modulated signal input to the high-frequency power amplifier at zero.

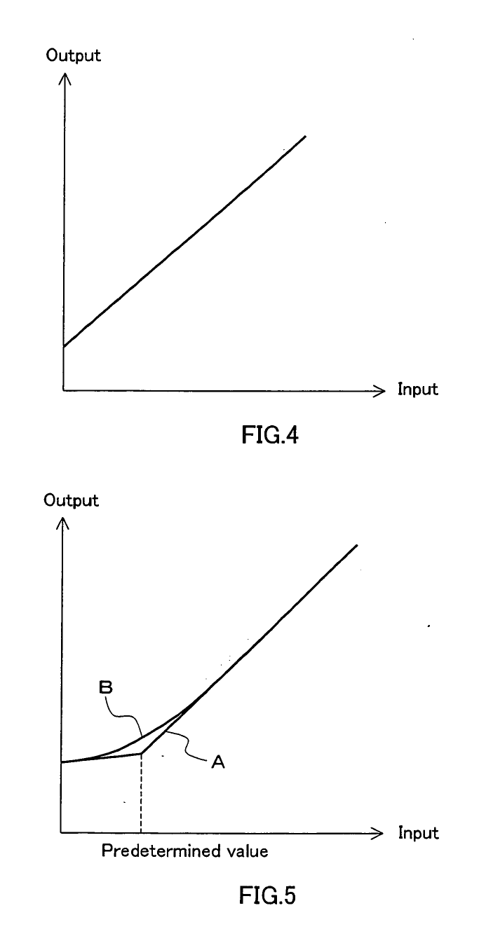

FIG. 4 shows an example of the input-output characteristics of the amplitude versus amplitude function section constituted by the amplitude conversion table 8. As shown in FIG. 4, examples of the amplitude conversion table 8 include an amplitude conversion table that outputs a value proportional to the sum of an input signal and a predetermined constant. Such an amplitude conversion table can be constructed with a simple circuit.

As shown in FIG. 5, examples of the amplitude conversion table 8 also include an amplitude conversion table in which the rate of change of y with respect to x is smaller than a predetermined value when x is smaller than a predetermined value, where x represents the absolute value of the input signal and y represents the absolute value of the output signal. The amplitude conversion table may have characteristics represented by a kinked line as the line A in FIG. 5, or characteristics represented by a curved line as the line B in FIG. 5. Here, the reason that x and y represent “absolute values” is that the input and the output of the amplitude conversion table 8 may be of negative polarity, depending on the characteristics of the envelope detecting section 2 or the voltage source 3. Generally, in the case of an OFDM modulated wave and the like, the variation in amplitude of the modulated signal with respect to time is significant in a period in which the amplitude of the modulated signal is small. By performing a conversion as shown in FIG. 5, it is possible to moderate the variation of the output signal with respect to time in a period in which the amplitude of the modulated signal is small (i.e., in a period in which the value of the horizontal axis is small). Therefore, it is possible to suppress high-frequency components of the bias voltage generated by the voltage source 3, thus smoothing the frequency characteristics that should be achieved by the circuit.

Examples of the amplitude conversion table 8 that achieves characteristics as shown in FIG. 5 include an amplitude conversion table that outputs a value proportional to the square root of the sum of the square of an input signal and a predetermined positive constant. It is possible to configure the amplitude conversion table 8 with a simple circuit by representing the amplitude conversion table 8 by such simple calculations.

It should be noted that in the present embodiment described above, one or both of the bias driving section and the high-frequency driving section may include an amplitude non-linearity compensation table, in order to compensate for non-linearity in bias voltage versus output voltage, or non-linearity in high-frequency input voltage versus output voltage of the high-frequency power amplifier. This table may be synthesized with the amplitude conversion table 8 or the complex number table 6 into a single table.

### Embodiment 2

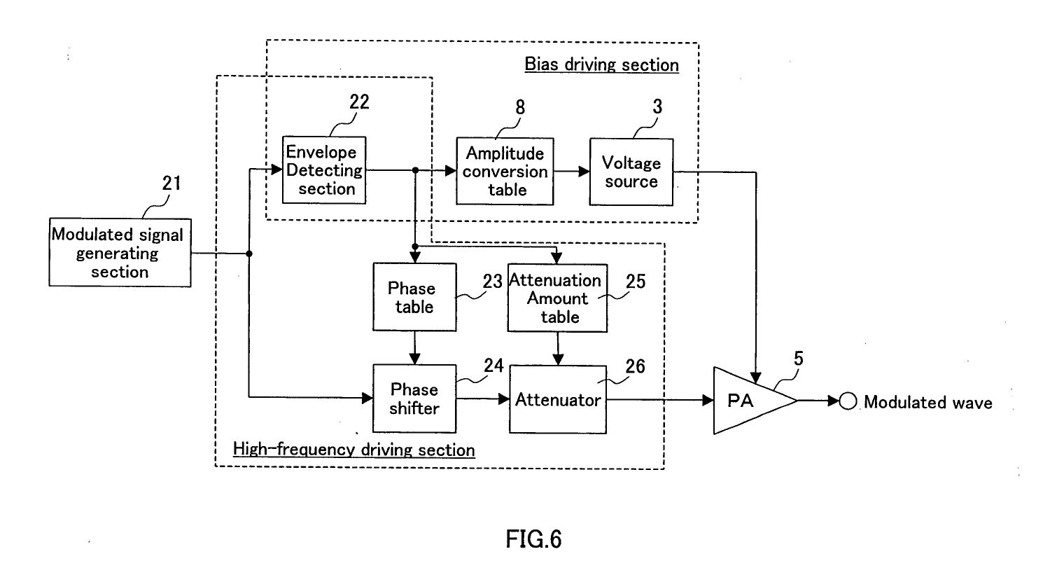

FIG. 6 is a circuit block diagram showing an example of the configuration of a transmitting device according to Embodiment 2 of the present invention. This is a modification of Embodiment 1 in which a modulated wave is obtained by generating a modulated signal in a high-frequency band without performing frequency conversion. As shown in FIG. 6, this transmitting device includes: a modulated signal generating section 21 that generates a modulated signal; an envelope detecting section 22 that receives one of two branched modulated signals; a phase table 23 that receives the first of three branched output signals from the envelope detecting section 22; a phase shifter 24 that receives the other of the two branched modulated signals and an output signal from the phase table 23; an attenuation amount table 25 that receives the second of the three branched output signals from the envelope detecting section 22; an attenuator 26 that receives an output signal from the phase shifter 24 and an output signal from the attenuation amount table 25; an amplitude conversion table 8 that receives the third of the three branched output signals from the envelope detecting section 22; a voltage source 3 that receives an output signal from the amplitude conversion table 8; and a high-frequency power amplifier 5 whose power supply terminal receives an output voltage of the voltage source 3 and whose high-frequency input terminal receives an output signal from the attenuator 26.

The envelope detecting section 22, the phase table 23 and the phase shifter 24 correspond to an amplitude versus phase function section. The amplitude versus phase function section, the attenuation amount table 25 and the attenuator 26 correspond to a high-frequency driving section. Furthermore, the amplitude conversion table 8 corresponds to an amplitude versus amplitude function section, and the amplitude versus amplitude function section, the envelope detecting section 22 and the voltage source 3 correspond to a bias driving section.

In the following, the operation of a transmitting device according to the present embodiment is described with reference to FIG. 6.

The modulated signal generating section 21 carries out a modulation such as QAM or OFDM based on data generated internally or data supplied externally, and outputs a modulated signal. The envelope detecting section 22 outputs an amplitude component by determining the envelope of the modulated signal. The phase table 23 stores in advance a value that compensates for the fluctuation in phase difference between the input and output of the high-frequency power amplifier 5, and outputs a phase for compensating for the variation in the phase difference in accordance with the value of the amplitude component output from the envelope detecting section 22. The phase shifter 24 provides, to the modulated signal, a phase for compensating for the fluctuation in phase difference, thereby outputting a phase-compensated modulated signal. The attenuation amount table 25 stores in advance a value that compensates for non-linearity in amplitude between the input and output of the high-frequency power amplifier 5, and outputs an attenuation amount that compensates for the non-linearity in accordance with the value of the amplitude component output from the envelope detecting section 22. The attenuator 26 provides the attenuation amount to the phase-compensated modulated signal, thereby outputting a phase- and amplitude-compensated modulated signal. The amplitude conversion table 8 converts the amplitude component output from the envelope detecting section 22 into a value in a predetermined range that excludes zero. The voltage source 3 generates a bias voltage based on the amplitude component in a predetermined range. The high-frequency power amplifier 5 is driven by the bias voltage supplied to the power supply terminal, amplifies the phase- and amplitude-compensated modulated signal, and outputs a high-frequency band modulated wave whose amplitude and phase vary.

In the following, the operation of the amplitude versus phase function section composed of the envelope detecting section 22, the phase table 23 and the phase shifter 24 is described in detail.

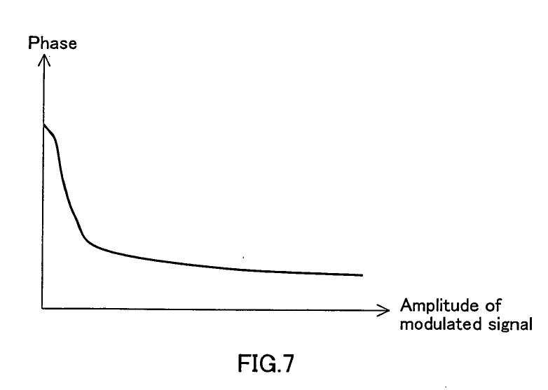

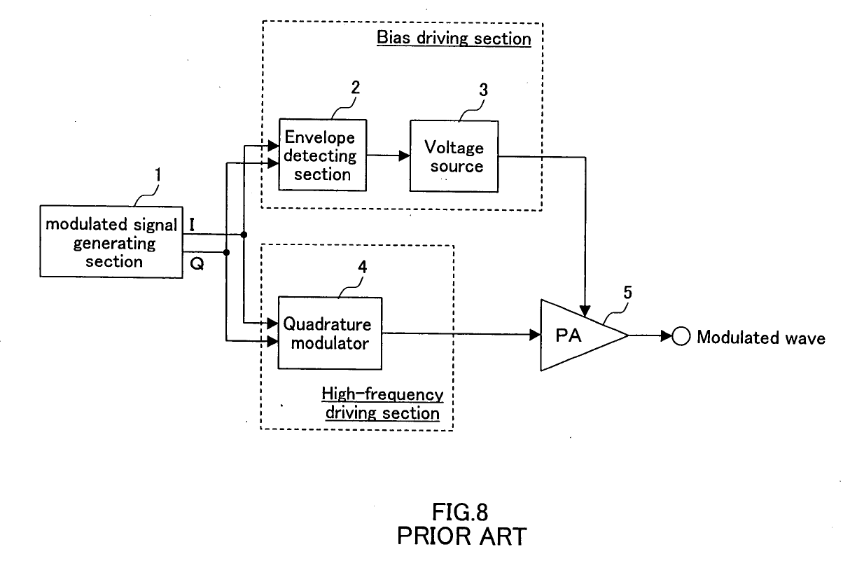

For the sake of simplicity, a case is described where the bias driving section is composed of the envelope detecting section 22 and the voltage source 3 as in the conventional configuration and does not include the amplitude conversion table 8. FIG. 2 shows an example in which the phase difference between the input and output of the high-frequency power amplifier varies with the bias voltage. In FIG. 2, the phase difference varies by several tens of degrees with the bias voltage. That is, since the bias voltage changes in accordance with the amplitude of the modulated signal, the high-frequency power amplifier 5 adds an excess phase fluctuation of several tens of degrees to the modulated signal. The value of the bias voltage with respect to the value of the amplitude component output from the envelope detecting section 22 can be known from the characteristics of the voltage source 3, so that the above-described excess phase fluctuation for the value of the amplitude component can be known. A phase opposite to the excess phase fluctuation is stored in advance in the phase table 23. Then, the excess phase fluctuation is cancelled by inputting into the phase shifter 24, the phase that is output for the value of the amplitude component, and phase-shifting the modulated signal. FIG. 7 shows an example of the phase stored in the phase table 23.

In the following, the operation of the amplitude versus amplitude function section configured as the amplitude conversion table 8 is described in detail.

Again, reference is made to the above-described characteristics (FIG. 2) of the high-frequency power amplifier. As shown in FIG. 2, the high-frequency power amplifier 5 often shows a significant variation in phase difference between input and output with respect to the change in bias voltage, when the bias voltage is close to zero. The amplitude conversion table 8 converts the range of the amplitude component output from the envelope detecting section 22 into a value in a range that excludes zero. In accordance with this value, the voltage source 3 outputs a bias voltage higher than a predetermined value. That is, the high-frequency power amplifier 5 operates within a range where the fluctuation in phase difference between input and output is moderate, and the excess phase fluctuation added to the modulated signal become small. Accordingly, the phase fluctuation that should be cancelled with the amplitude versus phase function section becomes small.

This makes it possible to precisely cancel the excess phase fluctuation with the amplitude versus phase function section. Alternatively, when the phase fluctuation that should be cancelled is very small, it is possible to omit the amplitude versus phase function section. Furthermore, since the bias voltage that should be output from the voltage source 3 does not include zero, it is possible to simplify the circuit of the voltage source 3. For example, it is not necessary to provide a negative power supply for the operating voltage of the voltage source 3. In addition, a bias voltage that is not zero causes no problem, because a modulated wave whose amplitude varies to zero can be output by setting the amplitude of the high-frequency band modulated signal input to the high-frequency power amplifier 5 at zero.

FIG. 4 shows an example of the input-output characteristics of the amplitude versus amplitude function section constituted by the amplitude conversion table 8. As shown in FIG. 4, examples of the amplitude conversion table 8 include an amplitude conversion table that outputs a value proportional to the sum of an input signal and a predetermined constant. Such an amplitude conversion table 8 can be configured with a simple circuit.

As shown in FIG. 5, examples of the amplitude conversion table 8 also include an amplitude conversion table in which the rate of change of y with respect to x is smaller than a predetermined value when x is smaller than a predetermined value, where x represents the absolute value of the input signal and y represents the absolute value of the output signal. The amplitude conversion table may have characteristics represented by a kinked line as the line A in FIG. 5, or characteristics represented by a curved line as the line B in FIG. 5. Here, the reason that x and y represent “absolute values” is that the input and the output of the amplitude conversion table 8 may be of negative polarity, depending on the characteristics of the envelope detecting section 22 or the voltage source 3. Generally, in the case of an OFDM modulated wave and the like, the variation in amplitude of the modulated signal with respect to time is significant in a period in which the amplitude of the modulated signal is small. By performing a conversion as shown in FIG. 5, it is possible to moderate the variation in output with respect to time in a period in which the amplitude of the modulated signal is small (i.e., in a period in which the value of the horizontal axis is small). Therefore, it is possible to suppress the high-frequency components of the bias voltage generated by the voltage source 3, thus smoothing the frequency characteristics that should be achieved by the circuit.

Examples of the amplitude conversion table 8 that achieves characteristics as shown in FIG. 5 include an amplitude conversion table that outputs a value proportional to the square root of the sum of the square of an input signal and a predetermined positive constant. It is possible to configure the amplitude conversion table 8 with a simple circuit by representing the amplitude conversion table 8 by such simple calculations.

It should be noted that in this embodiment described above, the bias driving section may include an amplitude non-linearity compensation table, in order to compensate for non-linearity in bias voltage versus output voltage of the high-frequency power amplifier 5. This table may be synthesized with the amplitude conversion table 8 into a single table.

As described above, the transmitting device according to the present invention has the advantage of being capable of outputting a modulated wave which suffers little deterioration in modulation accuracy, spectrum and the like, even in the case of using a high-frequency power amplifier in which the fluctuation in phase difference between input and output is large when a bias voltage is changed. Accordingly, the transmitting device of the present invention can be adapted, for example, for use in wireless LAN devices equipped with a transmitting device that outputs a modulated wave whose amplitude and phase vary, and in transmitting stations.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

1. A transmitting device comprising:
a modulated signal generating section that generates a modulated signal;
a high-frequency driving section that generates a high-frequency driving signal in response to the modulated signal;
a high-frequency power amplifier that amplifies the high-frequency driving signal; and
a bias driving section that detects an amplitude of the modulated signal and changes a bias voltage of the high-frequency power amplifier in accordance with a detected amplitude, the high-frequency power amplifier outputting a modulated wave whose amplitude and phase vary,
wherein the high-frequency driving section comprises an amplitude versus phase function section and provides, to the high-frequency driving signal, a phase shift that is opposite to a phase shift between input and output of the high-frequency power amplifier that occurs when the bias voltage of the high-frequency power amplifier changes with the amplitude of the modulated signal.

2. The transmitting device according to claim 1,
wherein the high-frequency driving section comprises a frequency converting section.

3. A transmitting device comprising:
a modulated signal generating section that generates a modulated signal;
a high-frequency driving section that generates a high-frequency driving signal in response to the modulated signal;
a high-frequency power amplifier that amplifies the high-frequency driving signal; and
a bias driving section that detects an amplitude of the modulated signal and changes a bias voltage of the high-frequency power amplifier in accordance with a detected amplitude, the high-frequency power amplifier outputting a modulated wave whose amplitude and phase vary,
wherein the bias driving section comprises an amplitude versus amplitude function section and provides v with a value in a predetermined range that excludes zero with respect to a full range of values that a can assume, where a represents an amplitude of the modulated signal and v represents a bias voltage of the high-frequency power amplifier.

4. The transmitting device according to claim 3,
wherein the high-frequency driving section comprises a frequency converting section.

5. The transmitting device according to claim 3,
wherein the amplitude versus amplitude function section outputs a value proportional to the sum of its input signal and a predetermined constant.

6. The transmitting device according to claim 3,
wherein a rate of change of y with respect to x is set to be smaller than a predetermined value when x is smaller than a predetermined value, where x represents an absolute value of an input signal and y represents an absolute value of an output signal of the amplitude versus amplitude function section.

7. The transmitting device according to claim 6,
wherein the amplitude versus amplitude function section outputs a value proportional to the square root of the sum of the square of an input signal and a predetermined positive constant.
